(19) United States
(12) Patent Application Publication
(10) Pub. No.: US 2011/0160327 A1
(43) Pub. Date: Jun. 30, 2011

(54) ISOCYANATE MODIFIED EPOXY RESIN FOR FUSION BONDED EPOXY FOAM APPLICATIONS

(75) Inventors: Ernesto Occhielio, Houston, TX (US); Fabio Aguirre, Lack Jackson, TX (US); Liao B. Zeng-Kun, Lake Jackson, TX (US)

(73) Assignee: DOW GLOBAL TECHNOLOGIES INC., Midland, MI (US)

(21) Appl. No.: 12/672,905

(22) PCT Filed: Aug. 28, 2008
(86) PCT No.: PCT/US2008/074604

§ 371 Date: Feb. 10, 2010

Related U.S. Application Data
(60) Provisional application No. 60/960,011, filed on Sep. 11, 2007.

(51) Int. Cl. C09D 179/04; C08G 18/00; B05D 7/24; B05D 5/00

(52) U.S. Cl. 521/156; 523/400; 528/73; 427/180

(57) ABSTRACT

Thermosetting powder coating compositions, wherein the compositions comprise an epoxy-terminated oxazolidinone-isocyanurate polymer and are capable of forming a foam when applied to a substrate in a powder coating process, as well as methods of making and uses of such compositions.

### BACKGROUND OF THE INVENTION

1. Field of the Invention

The present invention relates generally to isocyanate modified epoxy resins for fusion bonded epoxy foam applications and to powder coating compositions which comprise such resins.

2. Discussion of Background Information

The oil and gas pipe coating industry needs an insulating material to be applied on Fusion-Bonded Epoxy (FBE) coating for corrosion protection of steel pipelines operating at service temperatures >150° C. Currently available insulating materials like polypropylene or polyurethane foam, which have a softening point below 150° C., are not suitable for this purpose. Although isocyanurate and oxazolidinone foams are suitable for these high service temperatures a disadvantage associated therewith is that the application thereof requires a discontinuous process: first the FBE coating is applied onto the substrate (e.g., a pipe) and several hours later the composition for the foam coating is sprayed onto the FBE coated substrate. However, pipe coaters prefer to use a continuous process similar to the one currently used for multilayer systems. Accordingly, it would be advantageous to have available a coating system which affords a foam that is able to withstand high service temperatures and at the same time can be applied in a continuous process.

### SUMMARY OF THE INVENTION

The present invention provides thermosetting powder coating compositions which comprise an epoxy-terminated oxazolidinone-isocyanurate polymer and are capable of forming a cured foam coating when applied to a substrate under powder coating conditions.

In one aspect of the powder coating composition, the epoxy-terminated oxazolidinone-isocyanurate polymer may comprise a reaction product of one or more bisphenol diglycidyl ethers and one or more aromatic diisocyanates, e.g., the reaction product of a diglycidyl ether of bisphenol A and toluene diisocyanate (TDI). For example, the diglycidyl ether of bisphenol A may have an epoxy equivalent weight (EEW) of from about 160 to about 250, e.g., from about 170 to about 210 and/or the one or more bisphenol diglycidyl ethers and the one or more aromatic diisocyanates may be employed in amounts which afford a ratio of epoxy groups to isocyanate groups of from about 1.7:1 to about 2.7:1, e.g., from about 1.8:1 to about 2.2:1.

In another aspect, the reaction product may have a EEW of from about 230 to about 500, e.g., from about 320 to about 450, and/or the ratio of oxazolidinone rings to isocyanurate rings in the reaction product may be from about 100:0 to about 10:90, e.g., from about 80:20 to about 20:80.

In yet another aspect, the composition may comprise from about 65% to about 99% by weight of epoxy-terminated oxazolidinone-isocyanurate polymer, based on the total weight of the composition.

In a still further aspect, the composition of the present invention may comprise one or more curing agents.

The present invention also provides a method for providing a substrate (e.g., a metal substrate) with a coating, wherein the process comprises subjecting the substrate to a powder coating process with the powder coating composition of the present invention as set forth above (including the various aspects thereof) to produce a foam coating thereon. The foam coated substrate produced by this method is also provided by the present invention.

The present invention further provides a substrate (e.g., a metal substrate such as a steel pipe) which comprises a foam coating that is made from the powder coating composition of the present invention as set forth above (including the various aspects thereof), as well as a foam made from the powder coating composition.

The present invention further provides a thermosetting epoxy-terminated oxazolidinone-isocyanurate polymer, both in the uncured and cured state. The polymer, which is capable of forming a microcellular foam when applied to a substrate in a powder coating process in the form of a powder coating composition, comprises the product of the reaction of one or more diepoxy compounds which comprise a diglycidyl ether of bisphenol A and one or more diisocyanates which comprise toluene diisocyanate (TDI). The one or more diepoxy compounds and the one or more diisocyanates are employed in amounts which afford a ratio of epoxy groups to isocyanate groups of from about 1.7:1 to about 2.7:1, e.g., from about 1.8:1 to about 2.2:1.

In one aspect, diglycidyl ether(s) of bisphenol A and TDI may account for at least about 75% of the total weight of all diepoxy compounds and all diisocyanates which are employed.

In another aspect, the product may have an epoxy equivalent weight of from about 230 to about 500, e.g., from about 320 to about 450, and/or the ratio of oxazolidinone rings to isocyanurate rings in the product may be from about 100:0 to about 10:90, e.g., from about 80:20 to about 20:80.

In yet another aspect, the product may have a glass transition temperature of at least about 35° C. and/or the product may have a glass transition temperature of at least about 160° C. in the cured state.

Other features and advantages of the present invention will be set forth in the description of invention that follows, and will be apparent, in part, from the description or may be learned by practice of the invention. The invention will be realized and attained by the compositions, products, and methods particularly pointed out in the written description and claims hereof.

### BRIEF DESCRIPTION OF THE DRAWINGS

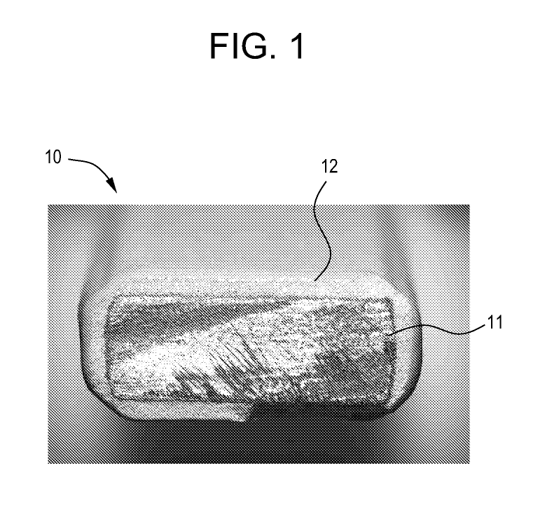

The present invention is further described in the detailed description which follows, in reference to the drawings by way of non-limiting examples of exemplary embodiments of the present invention, wherein the only FIGURE is FIG. 1 showing a photograph of a foam coating produced according the procedure described in Example 9 below.

### DETAILED DESCRIPTION OF THE PRESENT INVENTION

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show embodiments of the present invention in more detail than is necessary for the fundamental understanding of the present invention, the description making apparent to those skilled in the art how the several forms of the present invention may be embodied in practice.

The thermosetting powder coating composition of the present invention is capable of forming a cured foam (e.g., microcellular foam) coating when it is applied to a substrate under powder coating conditions (e.g., in a continuous coating process). One component of the composition is an epoxy-terminated oxazolidinone-isocyanurate polymer which can be cured at elevated temperatures and in the presence of curing catalysts for epoxy, oxazolidinone and/or isocyanurate group containing polymers.

The epoxy-terminated oxazolidinone-isocyanurate polymer preferably comprises a reaction product of one or more aromatic diisocyanates and one or more (at least partially) aromatic diepoxy compounds such as diglycidyl ethers of one or more bisphenols and in particular, bispenol A. A specific example of such a reaction product is the product of the reaction of a diglycidyl ether of bisphenol A and toluene diisocyanate (TDI).

The reaction of a diepoxy compound and a diisocyanate (carried out in the presence of a suitable catalyst at elevated temperature) can schematically be represented as follows:

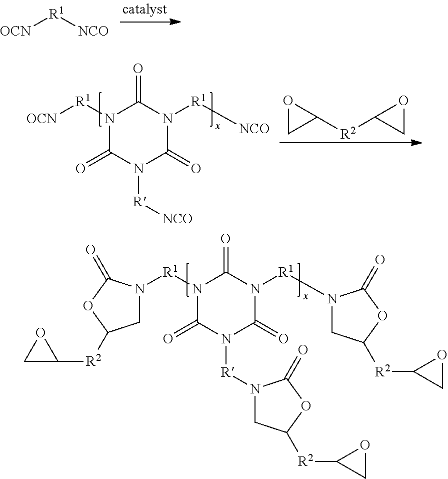

In the above reaction scheme, R¹ represents a divalent residue of an aromatic diisocyanate (for example, in the case of TDI it represents CH₃—C₆H₃), R² represents a divalent residue of a diepoxide (for example, in the case of the monomeric diglycidyl ether of bisphenol A, it represents O—C₆H₄—C(CH₃)₂—C₆H₄—O) and x may be 0 or an integer of 1 or higher.

According to the present invention it is preferred that diepoxy compound(s) and diisocyanate(s) are the only reactants and that additional reactants such as polyols, polyepoxides, polyisocyanates and the like are not present in the composition. If one or more of these additional reactants are present, they preferably account for not more than about 2%, e.g., not more than about 1% or not more than about 0.5% by weight of the total weight of all reactants used for the production of the epoxy-terminated oxazolidinone-isocyanurate polymer of the present invention.

The diglycidyl ether of the bisphenol (e.g., of bisphenol A) will usually have an (average) epoxy equivalent weight (EEW), defined herein as (average) molecular weight divided by the number of epoxy groups per molecule, of at least about 160, e.g., at least about 170 or at least about 180, but usually not higher than about 250, e.g., not higher than about 230, not higher than about 210, or not higher than about 190. The same applies to the average EEW if two or more bisphenol diglycidyl ethers (which may or may not include a bisphenol A diglycidyl ether) are employed.

The TDI will usually be employed as a mixture of the 2,4- and 2,6-isomers. Commercially available TDI usually contains these isomers in a ratio of about 80:20 (2,4:2,6).

The diepoxy compound(s) and the diisocyanate(s) will usually be employed in relative amounts which result in a ratio of epoxy groups (e.g., of diglycidyl ether of bisphenol A) to isocyanate groups (e.g., of TDI) which is not lower than about 1.7:1, e.g., not lower than about 1.8:1, or not lower than about 1.9:1, but usually not higher than about 2.7:1, e.g., not higher than about 2.5:1, not higher than about 2.2:1, or not higher than about 2:1.

If more than one diepoxy compound and/or more than one diisocyanate are employed for the production of the epoxy-terminated oxazolidinone-isocyanurate polymer, diglycidyl ether(s) of bisphenol A and TDI will usually account for at least about 50%, preferably at least about 75%, e.g., at least about 90% or at least about 95% of the total weight of all diepoxy compounds and all diisocyanates which are employed.

Non-limiting examples of diepoxy compounds which are different from diglycidyl ether(s) of bisphenol A and which may be used (usually in an amount which is not higher than about 40%, e.g., not higher than about 30%, not higher than about 20%, or not higher than about 10% by weight of the total amount of diepoxy compounds employed) for the production of the epoxy-terminated oxazolidinone-isocyanurate polymer of the present invention include diglycidyl ethers of diols such as, e.g., brominated bisphenol A, bisphenol F, bisphenol K (4,4′-dihydroxybenzophenone), bisphenol S (4,4′-dihydroxyphenyl sulfone), hydroquinone, resorcinol, 1,1-cyclohexanebisphenol, ethylene glycol, propylene glycol, diethylene glycol, dipropylene glycol, butanediol, hexanediol, cyclohexanediol, 1,4-bis(hydroxymethyl)benzene, 1,3-bis(hydroxymethyl)benzene, 1,4-bis(hydroxymethyl) cyclohexane and 1,3-bis(hydroxymethyl)cyclohexane; diepoxy compounds such as, e.g., cyclooctene diepoxide, divinylbenzene diepoxide, 1,7-octadiene diepoxide, 1,3-butadiene diepoxide, 1,5-hexadiene diepoxide and the diepoxide of 4-cyclohexenecarboxylate 4-cyclohexenylmethyl ester; and glycidyl ether derivatives of novolacs such as phenol novolac, cresol novolac and bisphenol A novolac. These compounds are also non-limiting examples of diepoxy compounds which can be used, individually or as a combination of two or more thereof, if no diglycidyl ether(s) of bisphenol A are employed for the production of the epoxy-terminated oxazolidinone-isocyanurate polymer for the powder coating composition of the present invention.

Non-limiting examples of diisocyanate compounds which are different from TDI and which may be used (usually in an amount which is not higher than about 40%, e.g., not higher than about 30%, not higher than about 20%, or not higher than about 10% by weight of the total amount of diisocyanate compounds employed) for the production of the epoxy-terminated oxazolidinone-isocyanurate polymer of the present invention include methane diisocyanate, methylene bis(4-benzeneisocyanate) benzene (MDI), polymeric MDI, butane diisocyanate (e.g., butane-1,1-diisocyanate), ethylene-1,2-diisocyanate, trans-vinylene diisocyanate, propane-1,3-diisocyanate, 2-butene-1,4-diisocyanate, 2-methylbutane-1,4-diisocyanate, hexane-1,6-diisocyanate, octane-1,8-diisocyanate, diphenylsilanediisocyanate, benzene-1,3-bis(methyleneisocyanate), benzene-1,4-bis(methyleneisocyanate), isophorone diisocyanate, cyclohexane-1,3-bis(methyleneisocyanate), the isomers of xylenediisocyanate, bis(4-benzeneisocyanate) ether, bis(4-benzeneisocyanate) sulfide and bis(4-benzeneisocyanate) sulfone. These compounds are also non-limiting examples of diisocyanates which can be used, individually or as a combination of two or more thereof, if no TDI is employed for the production of the epoxy-terminated oxazolidinone-isocyanurate polymer for the powder coating composition of the present invention.

The resultant reaction product will usually have an (average) EEW which is not lower than about 230, e.g., not lower than about 260, not lower than about 290, or not lower than about 320, but usually not higher than about 500, e.g., not higher than about 470, or not higher than about 450.

The ratio of oxazolidinone rings to isocyanurate rings in the reaction product will usually range from close to about 100:0 (i.e., or almost no isocyanurate rings are present in the reaction product) to about 10:90. Preferably, the ratio will be not lower than about 15:85, e.g., not lower than about 20:80, or not lower than about 30:70.

The ratio of oxazolidinone rings to isocyanurate rings in the reaction product can be influenced by varying parameters such as reaction temperature, amount and type of catalyst(s), relative ratio of diepoxy and diisocyanate compounds and rate of addition of diisocyanate compound(s). In this regard, U.S. Pat. No. 5,112,932, the entire disclosure whereof is incorporated by reference herein may, for example, be referred to. The Examples below illustrate some of the ways by which the ratio of oxazolidinone rings to isocyanurate rings in the reaction product can be influenced.

The epoxy-terminated oxazolidinone-isocyanurate polymer of the present invention in the uncured state preferably has a glass transition temperature which is higher than the temperatures which are usually encountered during transport and storage of the polymer or the powder coating composition containing the polymer respectively, in order to avoid sintering of the powder. Accordingly, it is preferred for the glass transition temperature of the uncured polymer to be at least about 35° C., e.g., at least about 40° C., or at least about 42° C. Further, the polymer in the cured (hardened) state preferably has a glass transition temperature of at least about 160° C., e.g., at least about 165° C., at least about 168° C., or at least about 170° C.

The polymer of the present invention can be prepared in any manner, examples of which are well known to those skilled in the art. In this regard, U.S. Pat. No. 5,112,932 and EP 0 113 575 A1, incorporated by reference herein in their entireties, may, for example, be referred to.

Non-limiting examples of suitable catalysts for the reaction (formation of oxazolidinone rings and isocyanurate rings) include nucleophilic amines and phosphines. Specific examples thereof include nitrogen heterocycles such as, e.g., alkylated imidazoles (for example, 2-phenylimidazole, 2-methylimidazole, 1-methylimidazole, 2-methyl-4-ethylimidazole and 4,4′-methylene-bis(2-ethyl-5-methylimidazole); other heterocycles such as 1,8-diazabicyclo [5.4.0]undec-7-ene (DBU), diazabicyclooctene, hexamethylenetetramine, morpholine, piperidine; trialkylamines such as triethylamine, trimethylamine, benzyldimethylamine; phosphines such as triphenylphosphine, tritolylphosphine and triethylphosphine; quaternary salts such as triethylammonium chloride, tetraethylammonium chloride, tetraethylammonium acetate, tetraethyl ammonium bromide, benzyl triethyl ammonium chloride, triphenylphosphonium acetate, triphenylphosphonium iodide, ethyl triphenyl phosphonium iodide and benzyl triphenyl phosphonium bromide. Zinc carboxylate, organozinc chelate compounds, stannous octoate and trialkyl aluminum compounds are further non-limiting examples of catalysts that may be used for the production of the polymer of the present invention (of course, more than one catalyst may be used). The preferred catalysts are imidazole compounds. Particularly preferred catalysts are 2-phenylimidazole, 2-methylimidazole, 1-methylimidazole, 2-ethyl-4-methylimidazole and 4,4′-methylene-bis(2-ethyl-5-methylimidazole).

The catalyst or mixture of catalysts is generally employed in an amount of from about 0.01% to about 2%, e.g., from about 0.02% to about 1% or from about 0.02% to about 0.1% by weight, based on the combined weight of the diepoxy compound(s) and the diisocyanate(s) used.

The reaction is usually carried out in the substantial absence of a solvent. The reaction temperature will usually range from about 110° C. to about 200° C. Preferably, the reaction is conducted at a temperature of from about 120° C. to about 180° C. Most preferably, the reaction is conducted at a temperature of from about 130° C. to about 160° C.

The powder coating composition of the present invention will usually comprise at least about 65%, e.g., at least about 70%, at least about 75% or at least about 80%, but usually not more than about 99%, e.g., not more than about 95% or not more than about 90% by weight of epoxy-terminated oxazolidinone-isocyanurate polymer, based on the total weight of the composition. Further components of the composition include, but are not limited to, additives selected from curing agents and curing accelerators, pigments, flow control agents, fillers and one or more other polymers, especially one or more other epoxy resins, although other polymers are preferably not present in substantial amounts (e.g., preferably not more than a total of about 5%, e.g., not more than about 2% or not more than 1% by weight, based on the total weight of the composition). Specific examples of these additives are well known to those skilled in the art. Also, being present in the form of a powder, the composition of the present invention is preferably substantially free of any components which are liquids at room temperature (in particular, blowing agents).

Non-limiting examples of suitable curing agents and curing accelerators for the epoxy-terminated oxazolidinone-isocyanurate polymer of the present invention include, but are not limited to, amine-curing agents such as dicyandiamide, diaminodiphenylmethane and diaminodiphenylsulfone, polyamides, polyaminoamides, polyphenols, polymeric thiols, polycarboxylic acids and anhydrides such as phthalic anhydride, tetrahydrophthalic anhydride (THPA), methyl tetrahydrophthalic anhydride (MTHPA), hexahydrophthalic anhydride (HHPA), methyl hexahydrophthalic anhydride (MHHPA), nadic methyl anhydride (NMA), polyazealic polyanhydride, succinic anhydride, maleic anhydride and styrene-maleic anhydride copolymers, polyols, substituted or epoxy-modified imidazoles such as 2-methylimidazole, 2-phenyl imidazole and 2-ethyl-4-methyl imidazole, phenolic curing agents such as phenol novolac resins, tertiary amines such as triethylamine, tripropylamine and tributylamine, phosphonium salts such as ethyltriphenylphosphonium chloride, ethyltriphenylphosphonium bromide and ethyltriphenylphosphonium acetate, and ammonium salts such as benzyltrimethylammonium chloride and benzyltrimethylammonium hydroxide; and mixtures thereof. Curing agents and accelerators are preferably used in total amounts of from about 0.5% to about 20% by weight, based on the total weight of the powder coating composition.

The powder coating composition of the present invention may be prepared by any process which blends the components of the composition substantially uniformly. For example, dry blend, semi-dry blend or melt blend procedures may be used. The blend can then be pulverized to form the powder coating composition. Particles of the powder coating composition will preferably have a size of not more than about 300 microns.

The powder coating composition of the present invention can be applied to substrates by any desired powder coatings process such as, e.g., fluidized bed sintering (FBS), electrostatic powder coating (EPC) and electrostatic fluidized bed (EFB). In the fluidized bed sintering (FBS) process, a preheated substrate (e.g., a metal pipe) is immersed into the powder coating composition, which is kept suspended by a flow of air. The substrate to be coated is preheated to a temperature of, e.g., at least about 200° C., e.g., at least about 230° C., but usually not higher than to about 350° C., e.g., not higher than about 300° C., and contacted with the fluidized bed (e.g., immersed therein). The immersion time of the substrate depends, inter alia, on the thickness of desired (microcellular) foam coating.

In the electrostatic powder coating (EPC) process, the powder coating composition is blown by compressed air into an applicator where it is usually charged with a voltage of about 30 to 100 kV by a high-voltage direct current, and sprayed onto the surface of the substrate to be coated. Then it is baked in a suitable oven. The powder adheres to the cold substrate due to its charge. Alternatively, the electrostatically charged powder can be sprayed onto a heated substrate such as a pipe and allowed to cure with the residual heat of the substrate or with the help of external heat.

In the electrostatic fluidized bed (EFB) process, the above procedures are combined by mounting annular or partially annular electrodes over a fluidized bed containing the powder so as to produce an electrostatic charge of, for example, 50 to 100 kV. Substrates heated above the sintering temperature of the powder are dipped into the powder cloud without post-sintering, or cold or preheated substrates are provided with a powder coating by electrostatic methods and the coating is fused by post-sintering at temperatures specific for the powder.

Numerous substrates can be (foam) coated with the powder coating composition of the present invention. FIG. 1 shows a foam coated substrate, generally indicated by numeral 10, comprising a foam coating 11 covering a steel bar substrate 12. The preferred substrates useful in the present invention are metals (e.g., iron, steel, copper), in particular metal pipes. Examples of other materials which may be coated with the powder coating composition of the present invention include ceramic and glass materials. The foam coating made from the powder coating composition of the present invention may, for example, find use as insulating material for pipelines operating at high service temperatures (e.g., 150° C. and above). The powder coating composition may be applied using a continuous process similar to the one currently used for multilayer systems. Accordingly, there is no need for spraying or pouring a polyisocyanurate-formulated system on a substrate such as a steel pipe for several hours and there also is no need to cool down the substrate before applying the insulation system. When made from a properly formulated composition, the resulting FBE coating is capable of showing a regular cellular structure, a glass transition temperature of at least about 170° C., a low friability, good adhesion to an FBE primer on a substrate (e.g., a steel substrate) and a thermal stability of up to about 300° C.

Other applications of the polymer and composition of the present invention include that as flame retardants for thermoplastic polymers.

The present invention will be further illustrated by the following non-limiting Examples. In these Examples all reactions were carried out under dry conditions with a constant dynamic purge of nitrogen. Temperatures reported below are given with an accuracy of about ±2° C. The reaction temperature was controlled with two lamps, one of which is connected to a temperature controller (DigiSense, ID# 1603ECTC-3). IR analysis was performed on a Nexus 670 FT-IR spectrometer, paying particular attention to the isocyanate (—N═C═O) region (2400-1500 cm⁻¹). Epoxy equivalent weight (EEW) values were obtained via EEW titration using a Mettler DL55 Auto-Titrator.

### Example 1

A reactor was charged with 716 g of bisphenol A diglycidyl ether (D.E.R.383™ from The Dow Chemical Company, epoxy equivalent weight (EEW) about 180 g/eq.). After heating to 130° C., 350 mg of 2-phenylimidazole (Aldrich, >98%) was added. A total of 179 g of TDI (ratio 2,4-isomer/2,6-isomer=about 80/20) was divided into four portions and added separately:

Portion I, 42.1 g, added at 137-138° C. over 19 minutes (min).
Portion II, 48.7 g, added at 138-140° C. over 13 min, followed by digestion at this temperature for 15 min.
Portion III, 48.4 g, added at 145-147° C. over 34 min, followed by digestion at this temperature for 20 min.
Portion IV, 40 g, added at 154-155° C. over 19 min, followed by digestion at 158-160° C. for 30 min.

Thereafter, the temperature was raised to 168-170° C. over 5 min and maintained for 30 min whereafter the contents of the reactor were allowed to cool to room temperature. During this time the residual isocyanate content was measured by FT-IR (sharp isocyanate peak at 2275 cm⁻¹). Following the disappearance of the —N═C═O peak the reaction mixture was heated for another 20 min (total digestion time 50 min) and then poured onto an aluminum foil. The EEW of the resultant product was 363 g/eq, the ratio of oxazolidinone to isocyanurate rings therein was >98:2 (as determined by FT-IR peak heights at 1710 and 1750 cm⁻¹ for the isocyanurate and oxazolidinone, respectively), and the glass transition temperature (Tg) of the resin was 64° C. (measured by DSC).

### Example 2

A five-neck 1 liter glass reactor equipped with a mechanical stirrer, addition funnel, cooling condenser, N₂ inlet, thermometer and heating mantle was charged at 120° C. with 640 g of bisphenol A diglycidyl ether (D.E.R.383™ from The Dow Chemical Company, epoxy equivalent weight (EEW) about 180 g/eq, density 1.20 g/mL) and 300 mg of 2-phenylimidazole. A total of 160 g of TDI (ratio 2,4-isomer/2,6-isomer=about 80/20) was divided into three portions and added separately to the reactor. Specifically, following heating to 130° C., a 50 g portion of TDI was added at 130-135° C. within <10 min, followed by a 15 min holding period. A second 58 g portion of TDI was then added over 20 min at 140-142° C., followed by another 15 min holding period. The last 52 g of TDI was then added at 155-157° C. over a 30 min period, followed by a 5 min holding period. Then the temperature was raised to 150-155° C. over 5 min and maintained for 30 min, whereafter the temperature was raised to 165° C. over 5 min and maintained for 30 min before the contents of the flask were allowed to cool to room temperature. During this time the residual isocyanate content was measured by FT-IR (sharp isocyanate peak at 2275 cm⁻¹). The EEW of the resultant product was 334 g/eq, the molar ratio of oxazolidinone to isocyanurate rings therein was 66/34 (as determined by FT-IR peak heights at 1710 and 1750 cm⁻¹ for the isocyanurate and oxazolidinone, respectively), and Tg of the pure resin was 42° C. (measured by DSC).

### Example 3

A five-neck 1 liter glass reactor equipped with a mechanical stirrer, addition funnel, cooling condenser, N₂ inlet, thermometer and heating mantle was charged at 120° C. with 624 g of bisphenol A diglycidyl ether (D.E.R.383™ from The Dow Chemical Company, epoxy equivalent weight (EEW) about 180 g/eq, density 1.20 g/mL) and 310 mg of 2-phenylimidazole. A total of 176 g of TDI (ratio 2,4-isomer/2,6-isomer=about 80/20) was divided into three portions and added separately. Specifically, following heating to 130° C., a 55.8 g portion of the TDI was added at 130-135° C. over <15 min, followed by a 15 min holding period. A second 56.4 g portion of TDI was then added over 12 min at 143-145° C., followed by another 15 min holding period. The remaining 63.9 g portion of TDI was then added at 145-150° C. over a 22 min period, followed by a 5 min holding period. Then the temperature was raised to 150-155° C. over 5 min and maintained for 30 min, whereafter the temperature was raised to 165° C. over 5 min and maintained for 30 min before the contents of the flask were allowed to cool to room temperature. During this time the residual isocyanate content was measured by FT-IR (sharp isocyanate peak at 2275 cm⁻¹). The EEW of the resultant product was 338 g/eq, the molar ratio of oxazolidinone to isocyanurate rings therein was 52/48 (as determined by FT-IR peak heights at 1710 and 1750 cm⁻¹ for the isocyanurate and oxazolidinone, respectively), and Tg of the pure resin was 43° C. (measured by DSC).

### Example 4

A five-neck 1 liter glass reactor equipped with a mechanical stirrer, addition funnel, cooling condenser, N₂ inlet, thermometer and heating mantle was charged with 170 g of bisphenol A diglycidyl ether (D.E.R.383™ from The Dow Chemical Company, epoxy equivalent weight (EEW) about 180 g/eq, density 1.20 g/mL) and 60 mg of 2-phenylimidazole. Following heating to 130° C., a 10 g portion of TDI (ratio 2,4-isomer/2,6-isomer=about 80/20) was added at 130-135° C. within 10 min, followed by a 10 min holding period. A second 10 g portion of TDI was then added over 9 min, followed by another 10 min holding period. The last 10 g portion of TDI was then added over a 7 min period, followed by a 5 min holding period. The temperature was then raised to 140-145° C. over 5 min and maintained for 30 min. Finally, the temperature was raised to 150-155° C. over 5 min and maintained for 30 min before the contents of the flask were allowed to cool. During this time residual isocyanate was measured by FT-IR (sharp isocyanate peak at 2275 cm⁻¹). The EEW of the resultant product was 244 g/eq, the molar ratio of oxazolidinone to isocyanurate rings therein was 20/80 (as determined by FT-IR peak heights at 1710 and 1750 cm⁻¹ for the isocyanurate and oxazolidinone, respectively), and the viscosity of the resin at 150° C. was 8.4 poise (measured with a cone and plate viscometer).

### Example 5

The apparatus described in Example 2 was charged with 187 g of bisphenol A diglycidyl ether (D.E.R.383™ from The Dow Chemical Company, epoxy equivalent weight (EEW) about 180 g/eq) and 66 mg of 2-phenylimidazole. After heating to 130° C., a 10 g portion of TDI (ratio 2,4-isomer/2,6-isomer=about 80/20) was added at 130-135° C. within 6 min, followed by a 7 min holding period. A second 10 g portion of TDI was then added over 10 min, followed by another 8 min holding period. The last 10 g of TDI was then added over a 8 min period, followed by a 8 min holding period. The temperature was then raised to 140-145° C. over 5 min and maintained for 30 min, and then raised to 150-155° C. over 5 min and maintained for 30 min. The EEW of the resultant product was 238 g/eq, the molar ratio of oxazolidinone to isocyanurate rings therein was 15/85 (as determined by FT-IR peak heights), and the viscosity at 150° C. was 6.0 poise (measured with a cone and plate viscometer).

### Example 6

The apparatus described in Example 2 was charged with 170 g of bisphenol A diglycidyl ether (D.E.R.383™ from The Dow Chemical Company, epoxy equivalent weight (EEW) about 180 g/eq) and 60 mg of 2-phenylimidazole. After heating to 130° C., a 10 g portion of TDI (ratio 2,4-isomer/2,6-isomer=about 80/20) was added at 130-135° C. within 10 min, followed by a 11 min holding period. Thereafter the reaction mixture was heated to 140-145° C. and a second 10 g portion of TDI was then added over 13 min, followed by another 9 min holding period. The last 10 g portion of TDI was then added over a 10 min period, followed by a 5 min holding period. The temperature was then raised to 150-155° C. over 5 min and maintained for 30 min. The EEW of the resultant product was 264 g/eq, the molar ratio of oxazolidinone to isocyanurate rings therein was 55/45 (as determined by FT-IR peak heights) and the viscosity at 150° C. was 5.6 poise (measured with a cone and plate viscometer)

### Example 7

The apparatus described in Example 2 was charged with 170 g of bisphenol A diglycidyl ether (D.E.R.383™ from The Dow Chemical Company, epoxy equivalent weight (EEW) about 180 g/eq) and 100 mg of 2-phenylimidazole. The contents of the flask were heated to 165-175° C. and 30 g of TDI (ratio 2,4-isomer/2,6-isomer=about 80/20) was added over 45 min. After continued heating for 30 min, the contents of the flask were allowed to cool to room temperature. The EEW of the resultant product was 349 g/eq, the molar ratio of oxazolidinone to isocyanurate rings therein was 100/0 (as determined by FT-IR peak heights) and the viscosity at 150° C. was 9.6 poise (measured with a cone and plate viscometer).

The following Table summarizes Examples 1-7 and lists results and properties of three additional resins X to Z which were obtained in a manner similar to the procedures described above.

TABLE
Oxazolidinone Isocyanurate Epoxy Resins
Based on Toluene Diisocyanate

| Resin | (% Weight of TDI | Ratio | EEW of | |
|---|---|---|---|---|
| Product of | based on total | Oxazolidinone/ | Resin | Resin |
| Example | weight of TDI + | Isocyanurate in | Product | Tg |
| No. | Epoxy Resin) | Resin Product (%) | (Eq/g) | (° C.) |
| 1 | 20 | 100/0 | 455 | 64 |
| 2 | 20 | 66/34 | 334 | 42 |
| 3 | 22 | 52/48 | 338 | 43 |
| 7 | 15 | 100/0 | 349 | |
| 6 | 15 | 55/45 | 264 | |
| 4 | 15 | 20/80 | 244 | |
| 5 | 15 | 15/85 | 238 | |
| X | 15 | 10/90 | 243 | |
| Y | 20 | 76/24 | 336 | 36 |
| Z | 24 | | gelled | |

### Example 8

A Fusion Bonded Epoxy coating powder formulation was prepared by mixing 486.7 g of the product of Example 1 (isocyanate modified epoxy resin), 13.4 g of Amicure CG 1200 (dicyandiamide powder available from Air Products), 9.7 g of Epicure P 101 (2-methylimidazole adduct with bisphenol A epoxy resin available from Shell Chemical), 7.3 g of Curezol 2PHZ-PW (imidazole epoxy hardener available from Shikoku), 4.9 g of Modaflow Powder III (flow modifier, ethyl acrylate/2-ethylhexylacrylate copolymer in silica carrier manufactured by UCB Surface Specialties of St. Louis, Mo.), 128.0 g of Minspar 7 (feldspar filler) and 3.0 g of Cab-O-Sil M 5 (colloidal silica available from Cabot Corp.). A steel bar heated at 242° C. was immersed into the powder, to result in a Fusion-Bonded Epoxy foam coating showing a glass transition temperature of 169° C. and good adhesion to the steel substrate.

### Example 9

A Fusion Bonded Epoxy coating powder formulation was prepared by mixing 537.6 g of the product of Example 2 (isocyanate modified epoxy resin), 20.2 g of Amicure CG 1200, 10.8 g of Epicure P 101, 8.1 g of Curezol 2PHZ-PW, 5.4 g of Modaflow Powder III, 143.0 g of Minspar 7 and 3.6 g of Cab-O—Sil M 5. A steel bar heated at 242° C. was immersed into the powder, to result in a Fusion-Bonded Epoxy microcellular foam coating (see FIG. 1) showing a glass transition temperature of 165° C.

### Example 10

A Fusion Bonded Epoxy coating powder formulation was prepared by mixing 537.8 g of the product of Example 3 (isocyanate modified epoxy resin), 19.9 g of Amicure CG 1200, 10.8 g of Epicure P 101, 8.1 g of Curezol 2PHZ-PW, 5.4 g of Modaflow Powder III, 143.0 g of Minspar 7 and 3.6 g of Cab-O—Sil M 5. A steel bar heated at 242° C. was immersed into the powder, to result in a Fusion-Bonded Epoxy foam coating showing a glass transition temperature of 173° C.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A thermosetting powder coating composition, wherein the composition comprises an epoxy-terminated oxazolidinone-isocyanurate polymer and is capable of forming a foam when applied to a substrate in a powder coating process.

2. The powder coating composition of claim 1, wherein the epoxy-terminated oxazolidinone-isocyanurate polymer comprises a reaction product of one or more bisphenol diglycidyl ethers and one or more aromatic diisocyanates.

3. The powder coating composition of any one of claims 1 and 2, wherein the epoxy-terminated oxazolidinone-isocyanurate polymer comprises a reaction product of a diglycidyl ether of bisphenol A and toluene diisocyanate (TDI).

4. The powder coating composition of claim 3, wherein the diglycidyl ether of bisphenol A has an epoxy equivalent weight (EEW) of from about 160 to about 250.

5. The powder coating composition of claim 4, wherein the EEW is from about 170 to about 210.

6. The powder coating composition of any one of claims 2 to 5, wherein the one or more bisphenol diglycidyl ether(s) and the one or more aromatic diisocyanates are employed in amounts which afford a ratio of epoxy groups to isocyanate groups of from about 1.7:1 to about 2.7:1.

7. The powder coating composition of claim 6, wherein the ratio is from about 1.8:1 to about 2.2:1.

8. The powder coating composition of any one of claims 2 to 7, wherein the reaction product has an epoxy equivalent weight (EEW) of from about 230 to about 500.

9. The powder coating composition of claim 8, wherein the EEW is from about 320 to about 450.

10. The powder coating composition of any one of claims 2 to 9, wherein a ratio of oxazolidinone rings to isocyanurate rings in the reaction product is from about 100:0 to about 10:90.

11. The powder coating composition of claim 10, wherein the ratio is from about 80:20 to about 20:80.

12. The powder coating composition of any one of claims 1 to 11, wherein the composition comprises from about 65% to about 99% by weight of epoxy-terminated oxazolidinone-isocyanurate polymer, based on a total weight of the composition.

13. A method for providing a substrate with a coating, wherein the process comprises subjecting the substrate to a powder coating process with the powder coating composition of any one of claims 1 to 12 to produce a foam coating thereon.

14. The method of claim 13, wherein the substrate comprises a metal substrate.

15. The method of any one of claims 13 and 14, wherein the process comprises applying the powder coating composition of any one of claims 1 to 12 to a substrate which is at a temperature at which the composition is capable of forming a foam coating.

16. A foam made from the powder coating composition of any one of claims 1 to 12.

17. A coated substrate made by the method of any one of claims 13 to 15.

18. A thermosetting epoxy-terminated oxazolidinone-isocyanurate polymer, wherein the polymer comprises a product of the reaction of one or more diepoxy compounds which comprise a diglycidyl ether of bisphenol A and one or more diisocyanates which comprise toluene diisocyanate (TDI), the one or more diepoxy compounds and the one or more diisocyanates being employed in amounts which afford a ratio of epoxy groups to isocyanate groups of from about 1.7:1 to about 2.7:1 and wherein the polymer is capable of forming a foam under powder coating conditions.

19. The polymer of claim 18, wherein diglycidyl ether of bisphenol A and TDI account for at least about 75% of a total weight of all diepoxy compounds and all diisocyanates employed for making the polymer.

20. The polymer of any one of claims 18 and 19, wherein the polymer has an epoxy equivalent weight of from about 230 to about 500.

21. The polymer of any one of claims 18 to 20, wherein a ratio of oxazolidinone rings to isocyanurate rings in the polymer is from about 100:0 to about 10:90.

22. The polymer of any one of claims 18 to 21, wherein the uncured polymer has a glass transition temperature of at least about 35° C.

23. The polymer of any one of claims 18 to 22, wherein the polymer in a cured state has a glass transition temperature of at least about 160° C.
